(19) United States
(12) Patent Application Publication
(10) Pub. No.: US 2014/0182996 A1
(43) Pub. Date: Jul. 3, 2014

(54) Silver Coin Keeper

(71) Applicant: Keith Itzhak Bartfeld, Brooklyn, NY (US)

(72) Inventor: Keith Itzhak Bartfeld, Brooklyn, NY (US)

(21) Appl. No.: 13/966,268

(22) Filed: Aug. 13, 2013

Related U.S. Application Data
(60) Provisional application No. 61/682,357, filed on Aug. 13, 2012.

(51) Int. Cl. G07D 5/08

(52) U.S. Cl. CPC G07D 5/08
USPC 194/304

(57) ABSTRACT

A silver coin diagnostic tool adapted to be used with an existing cash register for separating coins minted from silver from those minted of cupro-nickel preferably includes a funnel entrance located at a top end thereof, an arresting arm seated beneath the funnel entrance, first and second passageways leading away from the arresting arm, a door located at an entrance of the second passageway. Notably, a mechanism is provided for detecting whether a coin contains silver after passing beyond the arresting arm and thereafter opening the door for directing the coin to a desired one of the first and second passageways.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Technical Field

This invention relates to metal detecting devices and, more particularly, to a diagnostic tool to be installed on existing cash registers and which would determine the material composition of coins as they are placed in the cash register, thus separating coins minted from silver from those minted of cupro-nickel.

Many consumers may be shocked to learn that their money can actually be worth more than its face value. Specifically, coins minted several decades ago have a monetary value significantly greater than that which is printed on their face. Today, coins produced by the United States Mint are manufactured of copper, nickel, and zinc material with the penny comprised of copper plated zinc and the nickel, dime and quarter all minted from a cupro-nickel material. Dimes, quarters and half dollars minted before 1965 however, were struck from 90 percent silver and thus they are worth considerably more than their modern counterparts.

Furthermore, the composition of coins has changed dramatically in the last several decades as a result of an ever increasing worldwide silver shortage. The coinage act of 1965 eliminated the use of silver in the minting of dimes and quarters, while the silver content of half-dollars was reduced from 90% to 40%. By 1970 silver was eliminated altogether from the half-dollar and today the only silver coins minted are commemorative coins and “Silver Proof” coins that can be purchased directly from the United States Mint. How much are silver coins worth? A silver quarter for instance minted between the years of 1932 to 1964 can be valued at anywhere from $5.00 to $15.00, a significant increase from its face value. Similarly a Kennedy half-dollar minted between 1965 and 1969 can be worth as much as $10.00.

2. Summary Of Invention

Accordingly, a need remains for a diagnostic tool to be installed on existing cash registers in order to detect silver in coins. The Silver Coin Keeper(1) invention satisfies this need because it would determine the material composition of coins as they are placed in the cash register. The Silver Coin Keeper is convenient and easy to use, lightweight yet durable in design, versatile in its application, and designed for separating coins minted from silver from those minted from cupro-nickel.

### BRIEF DESCRIPTION OF THE SEVERAL VIEWS OF THE DRAWINGS

FIG. 1 shows the entire Silver Coin Keeper and identifies all of its parts. It is shown just as one dime is allowed to pass the arresting arm.

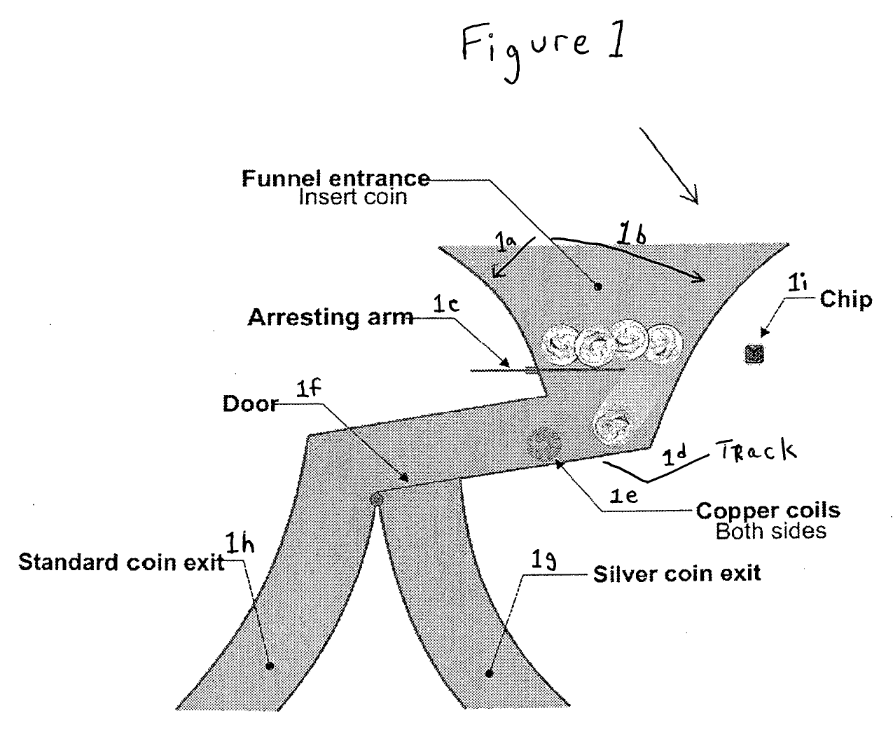

FIG. 2 shows the path that a dime would travel in the Silver Coin Keeper if it is determined to be silver.

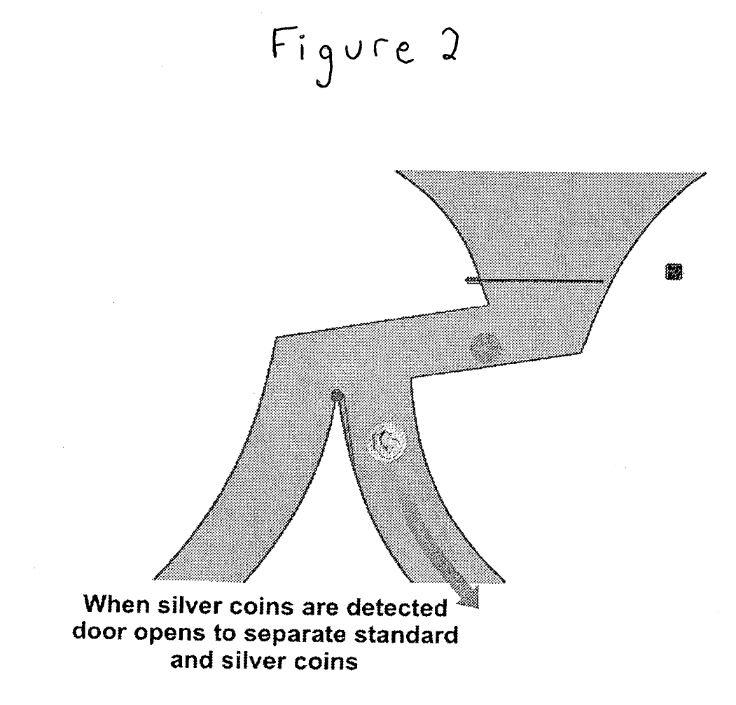

FIG. 3 shows the path that a dime would travel in the Silver Coin Keeper if it is determined to not be silver.

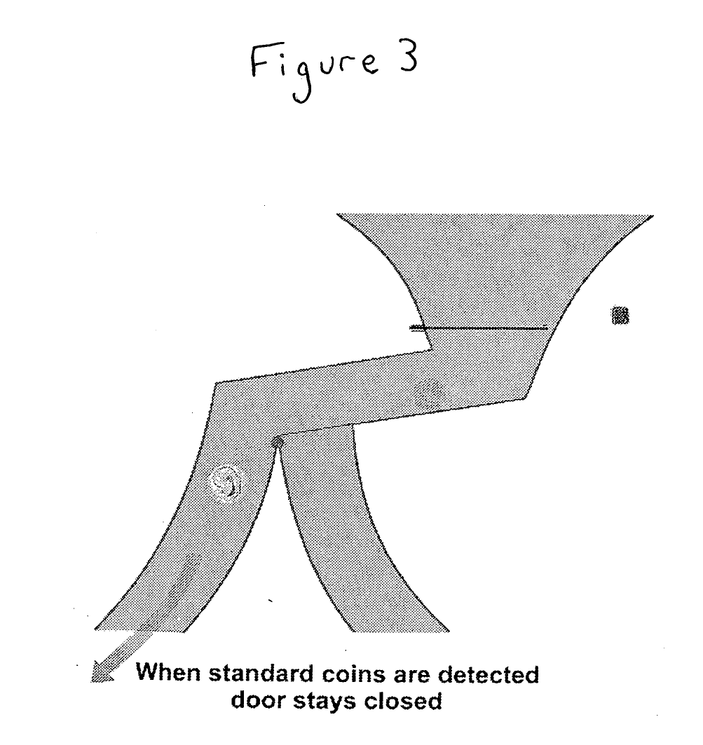

### DETAILED DESCRIPTION OF THE DISCLOSURE

The Silver Coin Keeper(1) would be a semicircular shaped unit configured to be connected directly to an existing cash register or incorporated into the design of newly manufactured cash registers. The Silver Coin Keeper(1) can be connected to a cash register's existing power supply or could operate on conventional 110 volt, 60 hertz power connected to any power outlet. It would have a sophisticated computerized system known as Eddy Current that reads the coins as they are dropped into the device in order to determine the material composition of the coin.

The Silver Coin Keeper would have a funnel entrance located at the top end (1a and 1b) thereof into which the the dimes, or quarters, or half-dollars would be deposited. An arresting arm (1c) would be seated beneath the funnel entrance to ensure that only one coin at a time enters the machine. The CPU (1i) (chip) would control the movement of the arresting arm. When the coin passes the arresting arm (1c) it will land on a track (1d). Notably, two copper coils (1e) facing each other on each side of the track (1d) will provide the Eddy Current which will detect whether a coin contains silver and thereafter the CPU (1i) (Central Processing Unit or Computer Chip) will open the door (1f) to direct the coin into the rear passage (1g). If the Eddy Current determines the coin to not be silver the door (1f) would remain closed and the coin would roll over the door into the chute (1h) leading toward the front of the cash register. It would then be used in regular business transactions.

More specifically, the way the Eddy Current would function is that an electric current would be sent through the copper coils producing an electromagnetic field. When the coin is passing through the device between the copper coils the coin disturbs the electromagnetic field which then disturbs the electrical current. Coins of different composition disturb the electrical field differently. The computer (CPU) (1i) detects these differences and therefore decides which coins are silver and which are not. The device is designed so that only one coin may be detected at a time, although a group of coins may be deposited at one time into the entry(funnel) (1a and 1b). Also, separate machines would be used for dimes and quarters due to their size difference. Quarters and dimes may be worth 21 times their face value, depending on the price of silver. In this manner all silver coins would be separated from those manufactured of less valuable material, thus enabling the store owner to cash in their coins for their true monetary value as opposed to merely their face value.

As many store owners simply don't have the time to manually examine each coin to determine its worth, the Silver Coin Keeper ensures that a 1963 quarter that is actually worth $15.00 will not be turned in to the bank as a mere 25 cent piece. Conscientious store owners might use the device as a courtesy for their customers, returning silver coins inadvertently utilized by a customer to that individual and explaining the true value of the coin as a means of promoting good will, fostering positive customer relations and encouraging repeat business.

In either case whether the operator chooses to keep the coin or let the customer in on the coin's true value, use of the Silver Coin Keeper may effectively ensure greater profits either through the monetary worth of the coin, or the newly established customer loyalty and positive word of mouth.

While the disclosure has been described with respect to certain specific embodiment(s), it will be appreciated that many modifications and changes may be made by those skilled in the art without departing from the spirit of the disclosure. It is intended, therefore, by the description herein above to cover all such modifications and changes as fall within the true spirit and scope of the disclosure. In particular, with respect to the above description, it is to be realized that the optimum dimensional relationship for the parts of the exemplary embodiment(s) may include variations in size, materials, shape, form, function, and manner of operation.

What is claimed as new and what is desired to secure by Letters Patent of the United States is:

1. A silver coin diagnostic tool adapted to be used with an existing cash register for separating coins minted from silver from those minted of cupro-nickel, said silver coin diagnostic tool comprising:
a funnel entrance located at a top end thereof;
an arresting arm seated beneath the funnel entrance;
first and second passageways leading away from said arresting arm;
a door located at an entrance of said second passageway; and
means for detecting whether a coin contains silver after passing beyond said arresting arm and thereafter opening said door for directing the coin to a desired one of said first and second passageways.
